(19) United States
(12) Patent Application Publication
(10) Pub. No.: US 2012/0102388 A1
(43) Pub. Date: Apr. 26, 2012

(54) TEXT SEGMENTATION OF A DOCUMENT

(76) Inventor: Jian Fan, San Jose, CA (US)

(21) Appl. No.: 13/227,136

(22) Filed: Sep. 7, 2011

Related U.S. Application Data
(60) Provisional application No. 61/406,780, filed on Oct. 26, 2010.
(60) Provisional application No. 61/513,624, filed on Jul. 31, 2011.

(30) Foreign Application Priority Data
Jul. 31, 2011 (US) PCT/US2011/046063

(51) Int. Cl. G06F 17/21

(52) U.S. Cl. 715/234

(57) ABSTRACT

A system and method are provided for segmenting text from a portable document format (PDF) document. The system includes a memory for storing computer executable instructions and a processing unit for accessing the memory and executing the computer executable instructions. The computer executable instructions include an engine to group line segments into text blocks using a homogeneity measure based on relative line space difference between line segments and a homogeneity measure based on difference in font size between line segments, where the line segments comprise text elements extracted from the PDF document.

### CROSS-REFERENCE TO RELATED APPLICATIONS

This application claims benefit of U.S. Provisional Application No. 61/406,780, filed Oct. 26, 2010, U.S. Provisional Application No. 61/513,624, filed Jul. 31, 2011, and International Application No. PCT/US2011/046063, filed Jul. 31, 2011, the disclosures of which are incorporated by reference in their entireties for the disclosed subject matter as though fully set forth herein.

### BACKGROUND

Printed publications are usually designed and edited professionally. The trend is to move from print content to a digital format, and provide the digital content online in a document. Some publishers offer publications digitally with use of a portable document format (PDF). PDF has been used as a standard for document exchange. An example is ADOBE® Acrobat, available from Adobe Systems Inc., San Jose, Calif. Existing text segmentation techniques may not perform well for documents in digital format, such as contemporary consumer magazines.

### DESCRIPTION OF DRAWINGS

FIG. 1A is a block diagram of an example of a document segmentation system.

FIG. 1B is a block diagram of an example of a computer that incorporates an example of the document segmentation system of FIG. 1.

FIG. 2 is a block diagram of an illustrative functionality implemented by an illustrative computerized document segmentation system.

FIGS. 3A, 3B and 3C show pages from example documents.

FIG. 4A shows an example paragraph from a document.

FIG. 4B illustrates bounding boxes of text quads retrieved from the paragraph of FIG. 4A.

FIG. 4C illustrates vertical centers computed from the bounding boxes of FIG. 4B.

FIGS. 5A and 5B show example paragraphs showing line segments and vertical center lines for the line segments.

FIGS. 6A and 6B show pages from example documents.

FIG. 7 illustrates example measures of relative difference between line spaces.

FIGS. 8A and 8B illustrate example boundary detection and segmentation from a paragraph.

FIGS. 9A to 9D illustrate text segmentation results from example documents.

FIG. 10 is a flow diagram of an example of document segmentation.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

An “image” broadly refers to any type of visually perceptible content that may be rendered on a physical medium (e.g., a display monitor or a print medium). Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

A “computer” is any machine, device, or apparatus that processes data according to computer-readable instructions that are stored on a computer-readable medium either temporarily or permanently. A “software application” (also referred to as software, an application, computer software, a computer application, a program, and a computer program) is a set of machine readable instructions that an apparatus, e.g., a computer, can interpret and execute to perform one or more specific tasks. A “data file” is a block of information that durably stores data for use by a software application.

The term “computer-readable medium” refers to any medium capable storing information that is readable by a machine (e.g., a computer). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

As used herein, the term “includes” means includes but not limited to, the term “including” means including but not limited to. The term “based on” means based at least in part on.

Text segmentation can be the first step toward reuse and repurposing of documents, including PDF documents. Existing text segmentation algorithms for PDF documents may not perform well for contemporary consumer magazines.

A system and method herein are applicable to PDF documents that are in true PDF format. As used herein, a PDF document in true PDF format is generated, for example, using a text processor, from a type of text markup, using a form of type-setting, or using a design or editing tool. The PDF documents may be generated using a converter. For example, the PDF documents may be generated using a typesetting system that creates PDF documents, or generates PDF documents using a PDF formatter, from an Extensible Markup Language (XML) file, a Hypertext Markup Language (HTML) file, a HTML file with Cascade Style Sheet (CSS), or a Scalable Vector Graphics (SVG) file. The PDF documents may be generated using an editor. The PDF documents may be generated using a development library. For example, the PDF documents may be generated using a PHP: Hypertext Preprocessor (PHP) library (including GOOGLE® fPDF), a C library, C++ library derived from Xpdf, or a Python-based PDF creation library. The PDF document may be generated from Javascript, a HTML file, an Extensible Hypertext Markup Language (XHTML) file, or HTML with CSS. The PDF document may be generated using PDF creator, such as a desktop publishing application. In an example, the PDF documents include searchable text. In an example, the PDF document is not a scanned document.

According to a system and method described herein, provided herein is a novel system and method for text segmentation from a document. The new local homogeneity measure is based on line space. A system and method described herein incorporate this feature into a region growing algorithm. Using a fixed set of parameters, a system and method described herein can achieve robust performance on documents, including PDF magazines, with wide-ranging layouts and styles.

Non-limiting examples of a document include portions of a web page, a brochure, a pamphlet, a magazine, and an illustrated book. In an example, the document is in static format. Some document publisher standards address only the issue of reflowing text. Recent document publishers developed to be run on portable document viewing devices use a significant amount of work by graphics and interaction designers to manually reformat the content and wire the user interactions. Non-limiting examples of portable viewing devices include touch-based devices, including smart phones, slates, and tablets, and other portable document viewing devices.

A system and method are provided for segmenting content from static documents, including digital publications such as magazines in true PDF format.

A PDF document can accurately preserve the visual appearance of electronic documents across application software, hardware, and operating systems, making it a widely used format for document sharing and archiving. However, PDF does not maintain logical structures of document content, such as words, paragraphs, titles, and captions. The lack of structural information can make it difficult to reuse and repurpose the digital content represented by a PDF document. A system and method provided herein for extracting logical structures from PDF documents has many real applications.

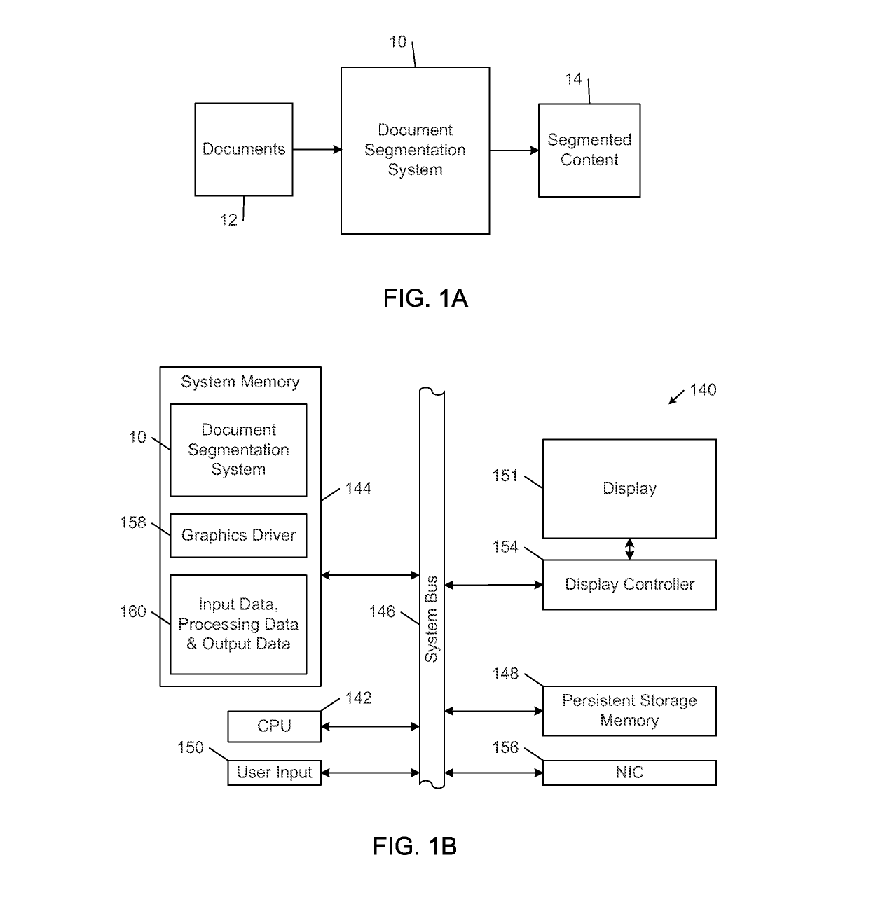

FIG. 1A shows an example of a document segmentation system 10 that performs document segmentation on documents 12 and outputs segmented document content 14. In an example implementation of the document segmentation system 10, text attribute retrieval is performed on the document, quads are merged into text line segments, and text line segments are grouped into text blocks. Document segmentation system 10 can provide a fully automated process for text segmentation.

In some examples, the document segmentation system 10 outputs the results from operation of document segmentation system 10 by storing them in a data storage device (including, in a database) or rendering them on a display (including, in a user interface generated by a software application). Example displays include the display screen of portable viewing devices, such as touch-based devices, including smart phones, slates, and tablets, and other portable document viewing devices.

FIG. 1B shows an example of a computer system 140 that can implement any of the examples of the document segmentation system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, digital video disks, a server, or a data center, including a data center in a cloud) that is connected to the system bus 146 and contains one or more computer-readable media disks that provide non-volatile or persistent storage for data, data structures and computer-executable instructions

Interactions may be made with the computer system 140 (e.g., by entering commands or data) using one or more input devices 150 (e.g., but not limited to, a keyboard, a computer mouse, a microphone, joystick, a touchscreen or a touch pad). Information may be presented through a user interface that is displayed to a user on the display 151 (implemented by, e.g., a display monitor), which is controlled by a display controller 154 (implemented by, e.g., a video graphics card). The display 151 can be a display screen of a portable viewing device. The computer system 140 also typically includes peripheral output devices, such as speakers and a printer. One or more remote computers may be connected to the computer system 140 through a network interface card (NIC) 156.

As shown in FIG. 1B, the system memory 144 also stores the document segmentation system 10, a graphics driver 158, and processing information 160 that includes input data, processing data, and output data. In some examples, the document segmentation system 10 interfaces with the graphics driver 158 to present a user interface on the display 151 for managing and controlling the operation of the document segmentation system 10.

In general, the document segmentation system 10 typically includes one or more discrete data processing components, each of which may be in the form of any one of various commercially available data processing chips. In some implementations, the document segmentation system 10 is embedded in the hardware of the media viewing device. In some implementations, the document segmentation system 10 is embedded in the hardware of any one of a wide variety of digital and analog computer devices, including desktop, workstation, and server computers. In some examples, the document segmentation system 10 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

The principles set forth in the herein extend equally to any alternative configuration in which document segmentation system 10 has access to a set of documents 12. As such, alternative examples within the scope of the principles of the present specification include examples in which the document segmentation system 10 is implemented by the same computer system (including the computing system of a media viewing device), examples in which the functionality of the document segmentation system 10 is implemented by a multiple interconnected computers (e.g., a server in a data center, including a data center n a cloud, and a user's client machine, including a portable viewing device), examples in which the document segmentation system 10 communicates with portions of computer system 140 directly through a bus without intermediary network devices, and examples in which the document segmentation system 10 has a stored local copies of the set of documents 12 that are to be transformed.

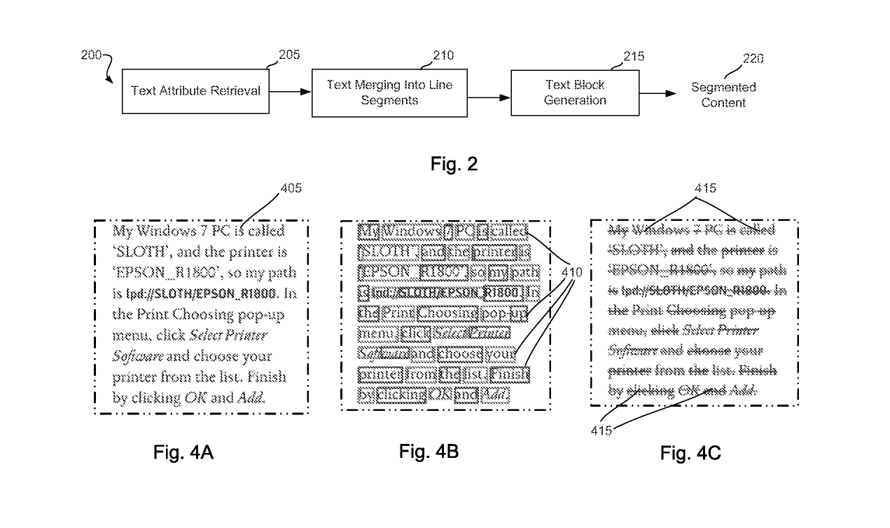

Referring now to FIG. 2, a block diagram is shown of an illustrative functionality 200 implemented by document segmentation system 10 for segmenting text content from a document, consistent with the principles described herein. Each module in the diagram represents one or more elements of functionality performed by the processing unit 142. The operations of each module depicted in FIG. 2 can be performed by more than one module. Arrows between the modules represent the communication and interoperability among the modules.

Text segmentation can be a first step taken towards logical structure extraction. Low level text entities can be grouped into line segments and homogeneous blocks. A system and method provided herein targets more complex PDF documents than those of simple style and layout. Text line segments need not be grouped based only on if they have the same font name, point size, and line space. Text line segments need not be required to have homogeneity regarding color to be grouped. Strict conditions on font name, size, and color need not be applied, since they may be valid for some technical documents, but may not apply to contemporary consumer magazines.

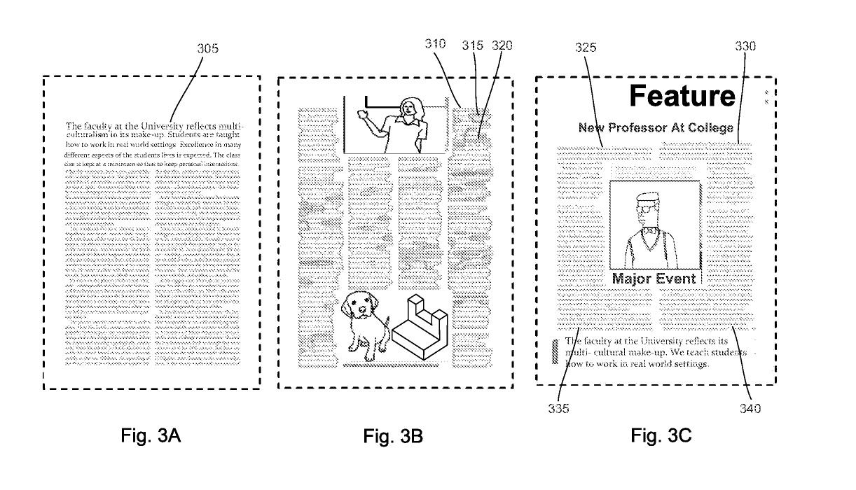

FIG. 3A is a page from an example PDF document. The font size of the first paragraph 305 gradually changes line by line. In addition, documents similar to the example of FIG. 3A may use various color and font families to highlight uniform resource locators (URLs) and other items. An existing technique that uses strict homogeneity requirement may result in severe over-segmentation. FIG. 3B shows the result of a segmentation operation that is based on a strict homogeneity requirement. For example, at 310, 315, 320 in FIG. 3B, a paragraph has been over-segmented into multiple segments in errors. A system and method herein need not be based on an assumption that a grouping criterion, the line space, is a constant, nor that it is associated one-to-one with a particular font on a global (page) scale. As a result, the over-segmentation in depicted in FIG. 3B does not occur. In addition, an existing technique that uses an optimized XY-cut for text segmentation may be too sensitive to parameters specifying the minimal width/height of a cut, and may not be able to handle L-shaped text layouts that can be common in documents such as consumer magazines. FIG. 3C illustrates a document with L-shaped text layouts, having L-shaped text portions 325, 330, 335, 340. Existing techniques may result in under-segmentation and not yield desirable results for a document such as FIG. 3C.

A system and method herein provide a novel homogeneity measure based on line space and a bottom-up region growing approach utilizing both the line space and font size measures. A system and method herein can be used to segment text from documents such as those depicted in FIGS. 3A, 3B and 3C.

The text segmentation described herein facilitates grouping of text into visually homogeneous blocks. A system and method herein facilitates extracting text from image and graphic components using existing PDF libraries. A system and method herein can be applied to text that follows horizontal reading order and is laid out as horizontal lines. In a system and method herein, local consistency need not be assumed between rendering order and reading order.

As depicted in FIG. 2, the operations of document segmentation system 10 for segmenting text content from a document to provide segmented content 220 can include text attribute retrieval in block 205, the merging of quads into text line segments in block 210, and the grouping of text line segments into text blocks in block 225.

The operations in block 205 of FIG. 2 for text attribute retrieval from the document can be performed as follows. In subsequent description, the relative difference of two non-negative values v₁ and v₂ can be defined as in Eq. (1):

$$Δ ( {v}_{1} , {v}_{2} ) = \{ \begin{matrix}0 , & if {v}_{1} = 0 and {v}_{2} = 0 \\ ∞ , & if ( {v}_{1} \cdot {v}_{2} = 0 and {v}_{1} \neq {v}_{2} \\ \vert {v}_{1} - {v}_{2} \vert / min ( {v}_{1} , {v}_{2} ) , & otherwise\end{matrix}$$

A PDF library and application programming interface (API) can be used for rendering and retrieving text attributes. A given document page can be opened and a WordFinder (PDWordFinder) created. Words (PDWord) and quads (ASFixedQuad) can be accessed via the WordFinder. Visual attributes that can be retrieved include font family, font size, color and bounding box.

In the segmentation, a system and method herein may group text characters of the document into units called quads. The quads are not necessarily the same as the words of the document. Words of the document may be identified as being comprised of one or more quads. For example, an upright word may have only one quad for all the text characters that make up the word. An upright hyphenated word may be identified as having two or more quads. If a word is on a curve in a document, it may be identified as having a quad for each character, or it may be identified as having two characters or more per quad.

FIGS. 4A-4C illustrate an example of bounding boxes of quads retrieved using PDWordGetNthQuad( . . . ). FIG. 4A shows an example paragraph 405 from a document. FIG. 4B illustrates bounding boxes 410 of text quads retrieved using PDF Library's WordFinder. FIG. 4C illustrates vertical center 415 computed for the bounding box of each of the text quads. As illustrated in FIG. 4B, the height of the bounding boxes 410 may vary significantly within the paragraph and even within a single text line due to differences in fonts. As illustrated in FIG. 4C, the position of vertical center 415 computed for each of the bounding boxes may fluctuate less in a line than either the top or bottom position of the bounding boxes.

The operations in block 210 of FIG. 2 for merging text quads into line segments are described. The results of block 210 is line segments. A line segment does not necessarily equal a logical text line. An assumption need not be made that the rendering order is the same as the reading order. The font size and spatial attributes are used. The quads are sorted in the order of top-down and left-to-right based on the vertical center position of the bounding boxes. Sorted order may not agree with reading order. The sorting may reduce the search range for neighboring quads.

In an example, the line-forming process proceeds by picking up a quad that has not been assigned a line identification to start a new line segment. The line segment is extended left and/or right by adding qualified quads to the growing line segment. When no qualified quad can be added to the line segment, a new line segment is started until all quads are assigned a line identification.

Criteria that can be applied to judge if two quads can be merged are as follows. An example criterion is the vertical overlap. The vertical overlap between two bounding boxes can be determined to be large enough such that:

O(qᵢ, qⱼ)>kₒ·min(hᵢ, hⱼ)

where O is the vertical overlap, h is the height of a quad, and k₀ is the threshold value (i.e., their corresponding quads) horizontally. In a non-limiting example, k₀ can be set to about 0.4. Another example criterion is the font size. The font size difference between the two quads can be determined to be small enough such that:

Δ(fᵢ, fⱼ)<k_{fh}

where f is the font size and k_{fh} is a threshold (a maximum relative font size difference for horizontal merge). In a non-limiting example, k_{fh} can be set to about 0.4. Another example criterion is the space. The space between the two quads can be determined to be small enough such that:

d_{i,j}<k_{dq}·min(fᵢ, fⱼ)

where d_{i,j} is the horizontal distance between two quads, and k_{dq} is the maximum space between horizontal words (i.e., their corresponding quads) to merge. In a non-limiting example, k_{dq} can be set to about 0.6. For text with horizontal reading order, text merging in the horizontal direction can be performed first. Two quads (including two words) can be merged if their horizontal distance is closer than a threshold value and meets the criteria described above.

Weighted-averaged font size and vertical center line may be used as the attributes of a line segment. The vertical center line of a line segment provides an indication of the position and extent of the line segment. Taking possible text variations within a line segment into account, these two attributes can be computed using weighted averaging. As a non-limiting example, the attributes of weighted-averaged font size (f_{L}) and vertical center line (y_{L}) can be computed as follows:

$${f}_{L} = ( {\sum }_{i} {f}_{i} \cdot {w}_{i} ) / {\sum }_{i} {w}_{i} and {y}_{L} = ( {\sum }_{i} {y}_{i} \cdot {w}_{i} ) / {\sum }_{i} {w}_{i} ,$$

where fᵢ, yᵢ and wᵢ are the font size, the vertical center, and the width of each quad i, respectively. The vertical center (yᵢ) of a quad i is determined based on the dimension and location of the bounding box of the respective quad i. The width of each quad (wᵢ) is used as the weighting factor in the computation.

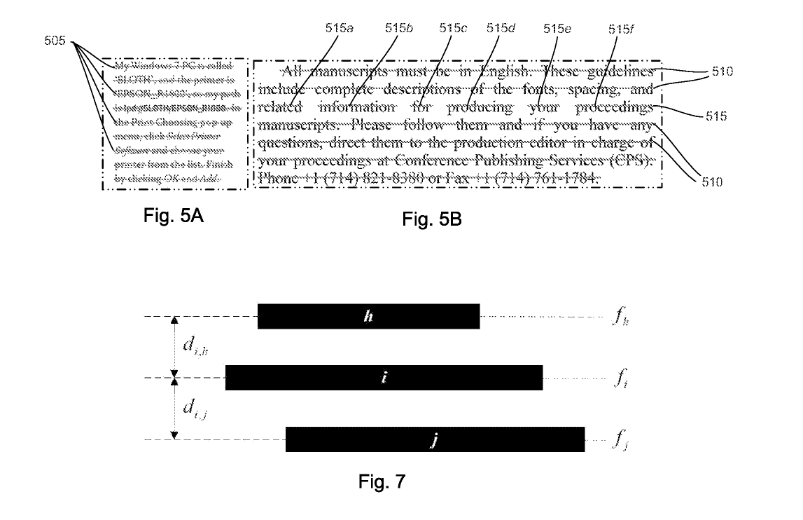

FIGS. 5A and 5B show examples of the vertical center lines computed for the resulting line segments. FIG. 5A shows the line segments determined from the paragraph of FIG. 3A. The line segments in FIG. 5A are determined to be the length of the logical text lines of the paragraph. The vertical center line 505 computed for each of the line segments is illustrated in FIG. 5A. As illustrated in the paragraph in FIG. 5B, there may be fragmentation of a logical text line for the paragraph. Most of the line segments 510 determined in FIG. 5B span the extent of a logical text line. Line 515 of FIG. 5B is determined to comprise of six different fragmented line segments (515a to 515f) that are not grouped into a single line segment. Each of the fragmented line segments in line 515 of FIG. 5B may have a different value of vertical center line (y_{L}).

The operations in block 215 of FIG. 2 for grouping of line segments into text blocks can be performed as described. The grouping of line segments into text blocks is performed using homogeneity measures based on line space and font size. Text line segments are merged into homogeneous text blocks. Fragmented line segments also can be re-grouped into logical lines, provided the line segments can be grouped into the same text blocks.

A homogeneity measure based on line space can be used to determine the extent (i.e., block boundaries) of a text block by detecting a change in the line space between pairs of line segments in a portion of the document. If a change in line space is encountered, this can indicate that a new text block should be formed. Thus, the extent of the text block can be determined based on identifying a change in line space.

A homogeneity measure based on font size can be used to determine the block boundaries of a text block by detecting a change in the font size between pairs of line segments in a portion of the document. If a change in font size is encountered, this can indicate that a new text block should be formed. Thus, the extent of the text block can be determined based on identifying a change in font size.

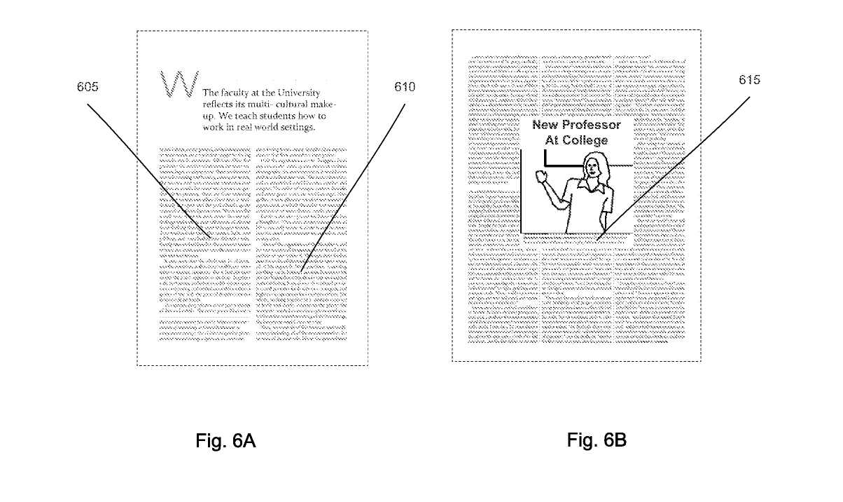

From a given line segment i, a text block recursively can take in a new line segment j with the following conditions. A first condition is based on a horizontal overlap that provides an indication of how much the horizontal extent of one line segment overlaps with the horizontal extent of another line segment in the vertical direction. Line segments are grouped if the horizontal overlap between the two line segments is taken to be non-zero. As a non-limiting example, two adjacent line segments in different columns may be determined to have zero horizontal overlap. In the illustration of FIG. 6A, a line segment identified in column 605 would have zero horizontal overlap with a line segment identified in column 610.

A system and method herein can be used to detect block boundaries during region growing. In detecting a block boundary, two measures may be applied. A homogeneity measure that can be applied may be based on line space. Where a change of line space alone may indicate a block boundary, a measure of relative difference between the two line spaces can be defined as: Δ(d_{i,j}, d_{i,h}), which is independent of font size. The relative difference between two line spaces can be computed according to Eq. (1). Line space parameters d_{i,j} and d_{i,h} are illustrated in FIG. 7 relative to line segments h, i, and j. The line space can be defined as the distance between two vertical center lines, as depicted in FIG. 7. The block boundary can be detected by comparing the relative line space difference with a threshold k_{dl}: line segment i is a block boundary if Δ(d_{i,j}, d_{i,h})>k_{dl}. In a non-limiting example, k_{dl} (a maximum relative line space difference for line merging) can be set to about 0.2. Another homogeneity measure that can be applied may be based on font size. A relative difference of font sizes can be expressed as Δ(f₁, f₂). The relative difference between two font sizes also can be computed according to Eq. (1). Line segment i can be determined as a block boundary if Δ(fᵢ, fⱼ)>k_{fl} or Δ(fᵢ, fₕ)>k_{fl}, where fᵢ, fⱼ and fₕ is the weighted-averaged font size within line segment i, j and h, respectively, and k_{fl} is the threshold relative font size difference for merging line segments. In a non-limiting example, k_{fl} can be set to about 0.25.

Using the line space homogeneity measure and the font size homogeneity measure, the block boundary as well as the type of boundary can be detected as follows:

$${B}_{i} = \{ \begin{matrix}0 , & if ( Δ ( {d}_{i , j} , {d}_{i , h} ) > {k}_{dl} \vert Δ ( {f}_{i} , {f}_{j} ) > {k}_{fl} \vert Δ ( {f}_{i} , {f}_{h} ) > {k}_{fl} ) \\ 1 , & else if ( {\hat{d}}_{i , h} + {w}_{f} \cdot Δ ( {f}_{i} , {f}_{h} ) ) > ( {\hat{d}}_{i , j} + {w}_{f} \cdot Δ ( {f}_{i} , {f}_{j} ) ) \\ - 1 , & otherwise\end{matrix}$$

where Bᵢ is a flag indicating whether line segment i is a boundary line and its type, w_{f} is a weight emphasizing either font size or line space, and \hat{d}_{i,h} and \hat{d}_{i,j} are normalized line spaces d_{i,j} and d_{h,i}: \hat{d}_{i,h}=d_{i,h}/max(d_{i,h}, d_{i,j}), \hat{d}_{i,j}=d_{i,j}/max(d_{i,h}, d_{i,j}). In a non-limiting example, w_{f} can be set to about 2.0. Boundary type “1” is used to indicate “top-down”, or that line segment i is closer to line segment j than to line segment h. On the other hand, boundary type “−1” is used to indicate “bottom-up”, or that line segment i is closer to line segment h than to line segment j.

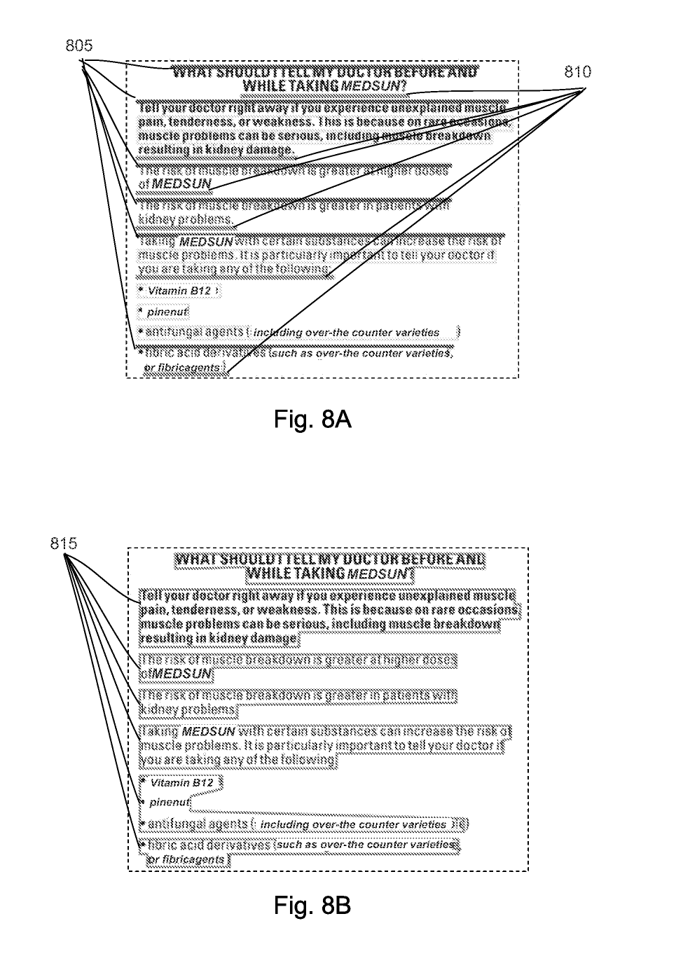

Non-limiting examples of boundary detection and the segmentation are shown in FIGS. 8A and 8B, respectively. In FIG. 8A, horizontal lines indicate “top-down” (805) and “bottom-up” (810) boundaries, while the boxes indicate non-boundary lines. In FIG. 8B, the polygons 815 surrounding the text indicate text blocks obtained from line growing according to a system and method herein.

After boundary detection, growing text blocks to facilitate text segmentation can be accomplished using region growing in the vertical direction (both up and down). Two neighboring line segments i and j with non-zero horizontal overlap and no other text between them are evaluated. For example, the line segments h and i in FIG. 7 can be considered to have non-zero horizontal overlap since the horizontal extent of line segment h overlaps with the horizontal extent of line segment i in the vertical direction. Similarly, the line segments i and j in FIG. 7 can be considered to have non-zero horizontal overlap since the horizontal extent of line segment i overlaps with the horizontal extent of line segment j in the vertical direction. Whether the two line segments should be merged can be determined based on three possible scenarios. In a first scenario, neither line segment i nor line segment j is a boundary line (Bᵢ=0 and Bⱼ=0). Here, line segments i and j can be merged. In a second scenario, only one of two line segments i and j is a block boundary. This includes four possible cases based on the relative position of the boundary line and the type of the boundary. In two of these cases, the two line segments may be merged: where the top line is a boundary line of the “top-down” type, or where the bottom line is a boundary line of the “bottom-up” type. For the other two cases, the two line segments may not be merged. In a third scenario, both line segments i and j are boundary lines. This also includes four cases since each boundary line can have two types. The two line segments may be merged if the top line is the “top-down” type and the bottom line is the “bottom-up” type. In this case, because the text block has only two lines, we may impose a stricter condition on the maximum line space, linking it to font size to avoid merging two lines very far apart.

In the example of FIGS. 8A and 8B, the results of FIG. 8B are derived using the boundary detection result of FIG. 8A. The layout of the bullet items in FIGS. 8A and 8B illustrate an example where text with the same font does not have the same line space globally. In this case, bullet items have the same font. However, the space between bullet items differs from the line space of text within a single item. The example of FIGS. 8A and 8B achieve the correct segmentation, in grouping text that belongs to a single item without splitting them. A c-style pseudo-code for the line segment grouping is given in FIG. 8B.

An example method and associated algorithm for performing the segmentation is described. A non-limiting example of a method for performing the segmentation can be performed according to an associated algorithm is included in Appendix A.

Examples of the parameters used in the algorithm in Appendix A are listed in Table I.

TABLE I
Algorithm Parameters.

| Parameter | Value | Description |
|---|---|---|
| k_{fh} | 0.4 | Maximum relative font size difference for |
| | | horizontal merge |
| k_{dq} | 0.6 | Maximum space between horizontal words (i.e., |
| | | their corresponding quads) to merge |
| kₒ | 0.4 | Minimum vertical overlap to merge two words |
| | | (i.e., their corresponding quads) horizontally |
| k_{fl} | 0.25 | Maximum relative font size difference for line |
| | | merging |
| k_{dl} | 0.2 | Maximum relative line space difference for line |
| | | merging |
| w_{f} | 2.0 | Weight for computing boundary orientation |

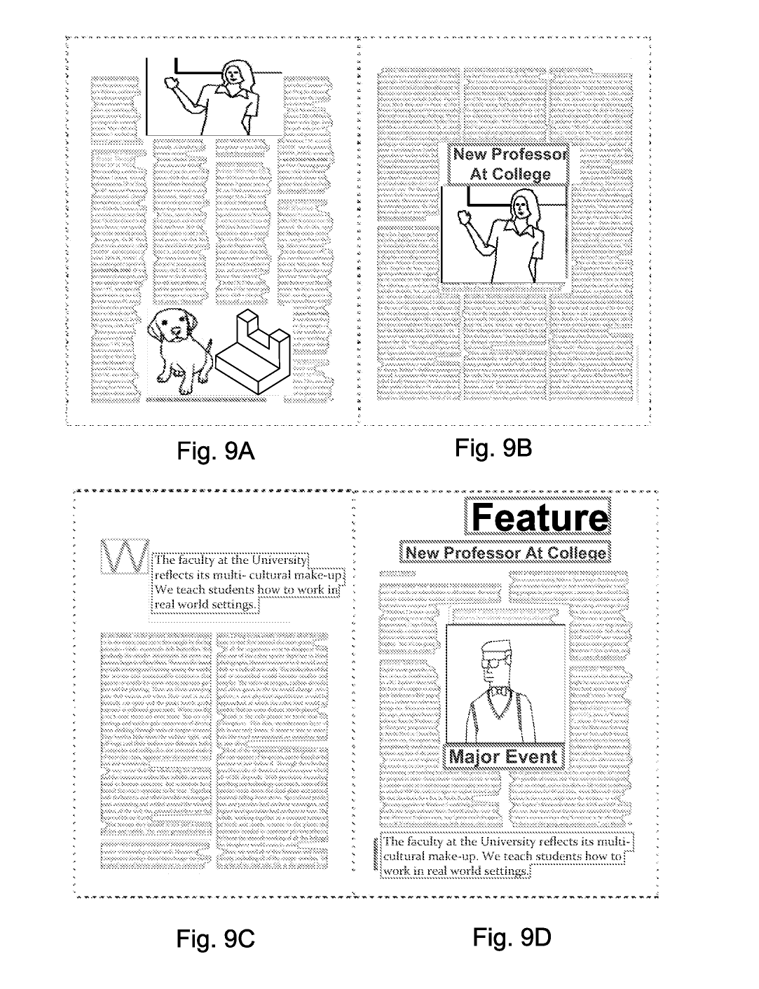

The threshold k_{dq} can be set low. In an example to accommodate a document having narrow column spaces in the pages, the threshold can be set to about 60% of font size, which deploys lines as column separators. A low threshold can cause more text line segments to be fragmented. The algorithm can achieve very satisfactory results on documents with different layout formats and different column spaces. FIGS. 9A to 9D illustrate text segmentation results from documents having different layouts and column spaces. The original document pages are shown in FIGS. 3A, 3B, 6A and 6B.

In an example implementation, precise quantitative evaluation for the segmentation of the document uses ground truth, which can be time-consuming and may involve some user-applied judgments. In another example implementation, content text blocks and captions can be counted and the corresponding segmentation results inspected. In an example, advertisement pages may not be counted. In another example, titles, tables and maps may not be counted. For example, for the example documents of FIGS. 9A, ten (10) text blocks were counted; for FIG. 9B, seven (7) text blocks were counted; for FIG. 9C, four (4) text blocks were counted; and for FIG. 9D, six (6) text blocks were counted.

Provided herein is a systematic method for text segmentation of documents, including PDF documents. A system and method herein provide a novel measure of line space and novel boundary detection based on combined relative differences of font size and line space. In an example, a method that is localized in nature can provide better results as compared to a technique that is associated with a global or top-down algorithm. A system and method herein can be applied to contemporary consumer magazines that contain complex layouts.

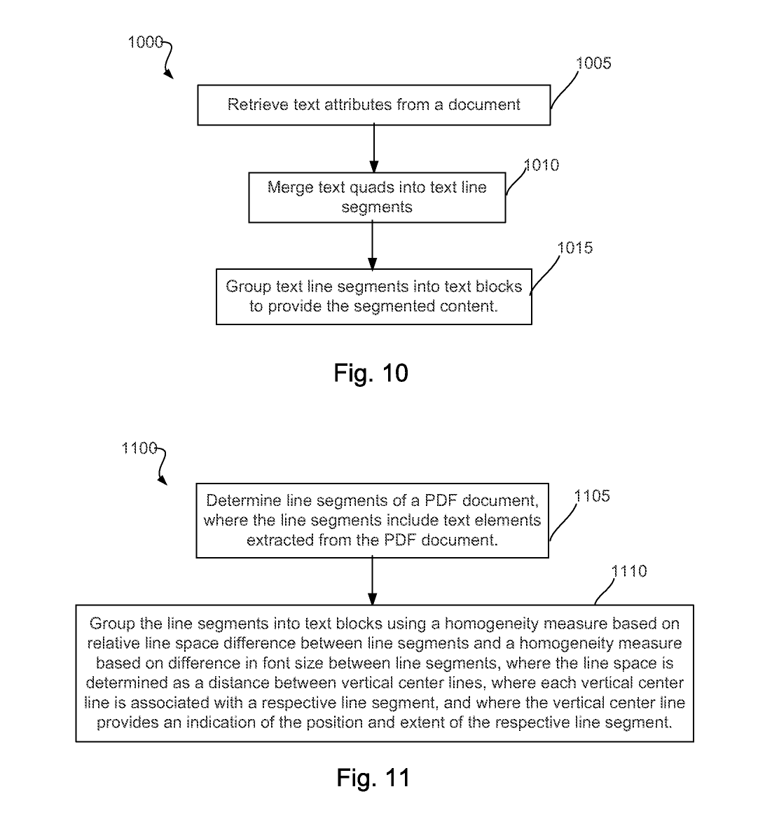

Referring now to FIG. 10, a flowchart is shown of a method (1000) summarizing an example procedure for segmenting text content from a PDF document to provide segmented content. This method (1000) may be performed by, for example, the processing unit (142, FIG. 1) coupled with document segmentation system (10, FIG. 1). The method (1000) includes retrieving text attributes from the document in (1005). The text quads are identified based on the text attributes. The method (1000) includes merging quads into text line segments (1010) using the results from (1005), and grouping text line segments into text blocks (1015). The document can be a PDF document. For example, document can be a PDF of an article, such as but not limited to a news article or a magazine article.

Referring now to FIG. 11, a flowchart is shown of a method (1100) summarizing an example procedure for segmenting text content from a PDF document to provide segmented content. This method (1100) may be performed by, for example, the processing unit (142, FIG. 1) coupled with document segmentation system (10, FIG. 1). The method includes determining (1105) line segments of a portable document format (PDF) document, where the line segments comprise text elements extracted from the PDF document. The method includes grouping (1110) the line segments into text blocks using a homogeneity measure based on relative line space difference between line segments and a homogeneity measure based on difference in font size between line segments, where the line space is determined as a distance between vertical center lines, where each vertical center line is associated with a respective line segment, and where the vertical center line provides an indication of the position and extent of the respective line segment.

The preceding description has been presented only to illustrate and describe embodiments and examples of the principles described. This description is not intended to be exhaustive or to limit these principles to any precise form disclosed. Many modifications and variations are possible in light of the above teaching.

Many modifications and variations of this invention can be made without departing from its spirit and scope, as will be apparent to those skilled in the art. The specific examples described herein are offered by way of example only, and the invention is to be limited only by the terms of the appended claims, along with the full scope of equivalents to which such claims are entitled.

As an illustration of the wide scope of the systems and methods described herein, the systems and methods described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise.

APPENDIX A
int GroupLineSegToBlocks(LineSeg *lines, int nlines) {

Sort lines in top-down and left-right based on the geometric

center point;

For each line segment, identify its vertical neighbors above and

below, and save the result with each line segment. Note that vertical
neighbor implies horizontal overlap.

Detect boundary lines and their type.
Initialize bid of all line segments to −1;
int bid = 0;
for(i=0;i<nlines;i++) {

if( lines[i].bid>=0 )

continue;

RegionGrow(lines,nlines,i,bid);
bid++;

```
  }
  return bid;
}
void RegionGrow (LineSeg *lines, int nlines, int seed,int bid) {
```

Queue q; // a FIFO quaeue
q.enqueue(seed);
lines[seed].bid = bid;

while( q.isEmpty( )==false ) {

int i = q.dequeue( );
for ( each neighbor line j above and below line i ) {

if( lines[j].bid>=0 )

continue;

merge = check if line j should be merged;
if ( merge==true ) {

lines[j].bid = bid;
q.enqueue(j);

}

}

}
}

What is claimed is:

1. A system to segment text from a portable document format (PDF) document, the system comprising:
memory for storing computer executable instructions; and
a processing unit for accessing the memory and executing the computer executable instructions, the computer executable instructions comprising:
an engine to group line segments into text blocks using a homogeneity measure based on relative line space difference between line segments and a homogeneity measure based on difference in font size between line segments, wherein the line segments comprise text elements extracted from the PDF document.

2. The system of claim 1, wherein the computer executable instructions further comprise instructions to extract the text elements of the PDF document.

3. The system of claim 2, wherein the computer executable instructions to extract the text elements comprise instructions to:
determine quads of the PDF document, wherein the quads are determined based on the text elements; and
retrieve visual attributes of the quads, wherein the visual attributes are selected from the group consisting of font family, font size, font color and bounding box.

4. The system of claim 3, wherein the computer executable instructions further comprise instructions to merge the quads into line segments based on the visual attributes.

5. The system of claim 4, wherein the visual attributes comprise bounding boxes, and wherein the computer executable instructions to merge the quads into line segments comprise instructions to:
sort the quads in the order of top-down and left-to-right based on vertical center positioning of the bounding boxes of the quads; and
grow each line segment by a method comprising:
selecting a quad that has not been assigned a line identification to start a line segment;
extending the line segment by grouping qualified quads to the left or to the right, wherein a candidate quad is determined as a qualified quad if the candidate quad and the previously added quad meet a predetermined criterion; and
ceasing to extend the line segment if no other qualified quads are identified.

6. The system of claim 5, wherein the predetermined criterion is a vertical overlap, a font size difference, or a space between the candidate quad and the previously added quad.

7. The system of claim 1, wherein the line space is determined as a distance between vertical center lines, wherein each vertical center line is associated with a respective line segment, and wherein the vertical center line provides an indication of the position and extent of the respective line segment.

8. The system of claim 7, wherein the homogeneity measure based on relative line space difference is determined as a relative line space difference (Δ(d_{i,j}, d_{i,h})), wherein to group the line segments into text block, the engine determines block boundaries of the text block by comparing the relative line space difference using a predetermined threshold k_{dl}, wherein a line segment i is determined as a block boundary of a text block if Δ(d_{i,j}, d_{i,h})>k_{dl}, wherein d_{i,h} is a distance between line segment h and line segment i, and wherein d_{i,j} is a distance between line segment j and line segment i.

9. The system of claim 8, wherein the homogeneity measure based on difference in font size is determined as a relative difference of font sizes Δ(f₁, f₂), wherein to group the line segments into text block, the engine determines a line segment i as a block boundary if Δ(fᵢ, fⱼ)>k_{fl} or Δ(fᵢ, fₕ)>k_{fl}, where fᵢ is the weighted average of font sizes within the line segment i, wherein fⱼ is the weighted average of font sizes within the line segment j, wherein fₕ is the weighted average of font sizes within the line segment h, and wherein k_{fl} is a predetermined threshold.

10. The system of claim 9, wherein the engine comprises computer executable instructions to determine a block boundary of the text blocks using the homogeneity measure and the font measure according to an expression:
$${B}_{i} = \{ \begin{matrix}0 , & if ( Δ ( {d}_{i , j} , {d}_{i , h} ) > {k}_{dl} \vert Δ ( {f}_{i} , {f}_{j} ) > {k}_{fl} \vert Δ ( {f}_{i} , {f}_{h} ) > {k}_{fl} ) \\ 1 , & else if ( {\hat{d}}_{i , h} + {w}_{f} \cdot Δ ( {f}_{i} , {f}_{h} ) ) > ( {\hat{d}}_{i , j} + {w}_{f} \cdot Δ ( {f}_{i} , {f}_{j} ) ) \\ - 1 , & otherwise\end{matrix}$$
where Bᵢ is a flag indicating whether line segment i is a boundary line, w_{f} is a weight that emphasizes either font size or line space, \hat{d}_{i,h} and \hat{d}_{i,j} are normalized line spaces d_{i,j} and d_{h,i}: \hat{d}_{i,h}=d_{i,h}/max(d_{i,h}, d_{i,j}), \hat{d}_{i,j}=d_{i,j}/max(d_{i,h}, d_{i,j}), wherein a value of Bᵢ=1 indicates that line segment i is closer to line segment j than to line segment h, and wherein a value of Bᵢ=−1 indicates that line segment i is closer to line segment h than to line segment j.

11. The system of claim 9, wherein, to group line segments into text blocks, the engine comprises computer executable instructions to:
apply a predetermined growing criterion to neighboring line segments, wherein the growing criterion determines if the neighboring line segments having non-zero horizontal overlap and no other text between them are to be merged; and
merge the neighboring line segments into a text block if the neighboring line segments meet the predetermined growing criterion.

12. The system of claim 1, wherein, to group line segments into text blocks, the engine comprises computer executable instructions to:
determine candidate lines of block boundaries of the text blocks;
apply a predetermined growing criterion to neighboring candidate line segments, wherein the growing criterion determines if the neighboring candidate line segments having non-zero horizontal overlap and no other text between them are to be merged; and
merge the neighboring candidate line segments into a text block if the neighboring candidate line segments meet the predetermined growing criterion.

13. A method performed using at least one processor of a computer system, the method comprising:
determining, using at least one processor, line segments of a portable document format (PDF) document, wherein the line segments comprise text elements extracted from the PDF document;
grouping, using at least one processor, the line segments into text blocks using a homogeneity measure based on relative line space difference between line segments and a homogeneity measure based on difference in font size between line segments, wherein the line space is determined as a distance between vertical center lines, wherein each vertical center line is associated with a respective line segment, and wherein the vertical center line provides an indication of the position and extent of the respective line segment.

14. The method of claim 13, wherein determining the line segments of the PDF document comprises:
determining quads of the PDF document, wherein the quads are determined based on the text elements;
retrieving visual attributes of the quads, wherein the visual attributes are selected from the group consisting of font family, font size, font color and bounding box; and
merging the quads into line segments based on the visual attributes.

15. The method of claim 14, wherein the visual attributes comprise bounding boxes, and wherein merging the quads into line segments comprises:
sorting the quads in the order of top-down and left-to-right based on vertical center positioning of the bounding boxes of the quads; and
growing each line segment by a method comprising:
selecting a quad that has not been assigned a line identification to start a line segment;
extending the line segment by grouping qualified quads to the left or to the right, wherein a candidate quad is determined as a qualified quad if the candidate quad and the previously added quad meet a predetermined criterion; and
ceasing to extend the line segment if no other qualified quads are identified.

16. The method of claim 15, wherein the predetermined criterion is a vertical overlap, a font size difference, or a space between the candidate quad and the previously added quad.

17. The method of claim 13, wherein grouping the line segments into text blocks comprises:
determining candidate line segments of block boundaries of the text blocks;
applying a predetermined growing criterion to neighboring candidate line segments, wherein the growing criterion determines if the neighboring candidate line segments having non-zero horizontal overlap and no other text between them are to be merged; and
merging the line segments between the neighboring candidate line segments into a text block if the neighboring candidate line segments meet the predetermined growing criterion.

18. A non-transitory computer-readable medium having code representing computer-executable instructions encoded thereon, the computer executable instructions comprising instructions executable to cause one or more processors:
determine line segments of a portable document format (PDF) document, wherein the line segments comprise text elements extracted from the PDF document; and
group the line segments into text blocks using a homogeneity measure based on relative line space difference between line segments and a homogeneity measure based on difference in font size between line segments, wherein the line space is determined as a distance between vertical center lines, wherein each vertical center line is associated with a respective line segment, and wherein the vertical center line provides an indication of the position and extent of the respective line segment.

19. The computer-readable medium of claim 18, wherein the computer executable instructions executable to cause one or more processors to determine the line segments of the PDF document comprises instructions executable to cause the one or more processors to:
determine quads of the PDF document, wherein the quads are determined based on the text elements;
retrieve visual attributes of the quads, wherein the visual attributes are selected from the group consisting of font family, font size, font color and bounding box; and
merge the quads into line segments based on the visual attributes.

20. The computer-readable medium of claim 18, wherein the computer executable instructions executable to cause one or more processors to group the line segments into text blocks comprises instructions executable to cause the one or more processors to:
determine candidate line segments of block boundaries of the text blocks;
apply a predetermined growing criterion to neighboring candidate line segments, wherein the growing criterion determines if the neighboring candidate line segments having non-zero horizontal overlap and no other text between them are to be merged; and
merge the line segments between the neighboring candidate line segments into a text block if the neighboring candidate line segments meet the predetermined growing criterion.
